(19) United States
(12) Patent Application Publication
(10) Pub. No.: US 2006/0102052 A1
(43) Pub. Date: May 18, 2006

(54) Amino alcohol stabilized colloidal silica

(76) Inventor: Ronald S. Doles, LaGrange Park, IL (US)

Correspondence Address: NALCO COMPANY, 1601 W. DIEHL ROAD, NAPERVILLE, IL, 60563-1198, US

(21) Appl. No.: 10/987,740

(22) Filed: Nov. 12, 2004

(51) Int. Cl. C04B 28/26; C04B 35/66; B28B 7/28

(52) U.S. Cl. 106/634; 106/38.22; 106/38.3

(57) ABSTRACT

A finely divided silica binder which is stabilized with an amino alcohol. It may be used to form a slurry for making high temperature casting shells, including a finely divided refractory material and water, providing improved stability to the slurry and other advantages.

### BACKGROUND OF THE INVENTION

Colloids or sols which contain silica are well known, and are used in a variety of ways, for example, for use in investment casting and other refractory material uses, or vacuum forming, catalysts, coatings, ceramics, wafer polishing, and CMP, for example.

Typically, colloidal silicas are conventionally stabilized with an alkali ion such as sodium, potassium, or ammonium. Sodium and potassium are particularly effective as high temperature fluxes for the residue (silica) that remains after water has evaporated from the colloid. The sodium or potassium present reduces the melting or softening point of the material. As a disadvantage, sodium and potassium encourage undesirable high temperature reactions, which in effect limit the high temperature use of sodium or potassium-stabilized silica-containing sols or colloids in the fields of investment casting, refractories, catalysts, and ceramics, for example. However, at lower temperatures, such alkali stabilized silicas can provide high strength casting shells with outstanding slurry stability and rheology.

Deionized, colloidal silicas and ammonia-stabilized colloidal silicas are alternatives to colloidal silicas that contain alkali metals such as sodium and potassium. These deionized and ammonia stabilized silicas exhibit improved high temperature performance, but they both have disadvantages. The deionized colloids are relatively unstable. The colloids have shortened shelf lives and working lives in investment casting applications. On the other hand, ammonia-stabilized colloids are stable for longer periods of time, but in an open environment the volatile ammonia is released which, of course, is undesirable if the workers are exposed to the ammonia fumes. Furthermore, colloid stability decreases as the ammonia volatilizes. This is very likely to happen in investment casting and other refractory use, since it is difficult to enclose the ammonia-containing colloids during use so that they are kept away from the workers. Furthermore, deionized and ammonia stabilized colloids often exhibit inferior low temperature strength, and mediocre slurry stability and rheology, when compared with sodium and potassium stabilized colloidal silicas.

### DESCRIPTION OF THE INVENTION

By this invention, it has been found that, particularly for use in investment casting and other refractory applications, colloidal silicas may be produced and stabilized by the presence of amino alcohols. If desired, alkali stabilized colloids can be deionized, and then restabilized by the addition of amino alcohols.

While certain colloidal silicas have been stabilized by the presence of nitrogen containing compounds as disclosed in U.S. Pat. No. 6,379,500, the use of such materials has been in papermaking, which requires very high surface area colloids which are typically unstable at concentrations above 10-15% solids, and have poor mechanical strength and other mechanical properties. By this invention, it has been found that silica colloids of larger, average particle size than that which is customarily used in papermaking, and generally having a higher solids content in the colloidal solution used, provide materials which are successful for use in refractory applications, to provide improved bonding strength and other properties in high temperature performance. Also, used as catalysts, good strength, attrition, and porosity can be provided by the silica colloids of this invention. In polishing, good hardness, abrasive properties, removal rates and surface finish can be provided. Likewise, in coatings, the colloidal silicas of this invention may provide good film properties, abrasion resistance, gloss, and porosity.

By this invention, an aqueous-silica colloid is provided which is stabilized with an amino alcohol, the silica present typically having an average particle size of about 50 to 125 nanometers (nm.), and in some embodiments greater than 50 nm., such as 60 to 100 nm.. In other embodiments, the average particle size may be about 11-20 nm..

Typically, about 0.1 to about 3 wt. percent of the amino alcohol is present, based on the weight of the silica binder, and the amino alcohol used typically has no more than 14 carbon atoms per molecule.

The above aqueous silica colloid is preferably found with a solids concentration of about 15-50 wt. percent, which is a level where the higher surface area silica sols used in papermaking are typically unstable. Typically, a solids concentration in excess of 20 wt. percent may be used.

Amino alcohols, used as stabilizers for aqueous silica colloids, are advantageous in that they generally have low volatility, low toxicity, good stability; and they can be used as dispersants. They have the capability of effective pH buffering, low reactivity, and make a good replacement for alkali metals. They burn out cleanly in investment casting and other refractory applications, having few or no ash/fluxing effects. Also, they have low odor and volatility, so that they are well suited to slurry coating and other processes where they, or the compositions containing them, are exposed to the atmosphere or environment.

Also by this invention, a slurry is also provided for high temperature casting, which comprises: a finely divided refractory material, water, and a finely divided silica colloidal binder which is stabilized with an amino alcohol as described above.

While it is believed that a large variety of amino alcohols, containing both at least one hydroxyl group and at least one primary, secondary, or tertiary amino group, are effective, two amino alcohols which are particularly useful comprise 2-amino-2-methyl-1-propanol and 2-dimethylamino-2-methyl-1-propanol. In an embodiment, the amino alcohols used have no more than about ten carbon atoms.

Slurry products which contain these silica colloids, stabilized with amino alcohols, have desirable low temperature performance in a manner similar to sodium and potassium-stabilized colloidal silicas, without the undesirable effects that can take place at high temperatures, as described above.

Slurries made with the stabilized silica in accordance with this invention may be used to form investment casting shells by the addition of sequential layers of said slurry and typically alternating layers of stucco. The refractory and the stucco may each comprise, for example, zirconium silicate (zircon), zirconia, fused silica, alumina, yttria, aluminum/silicate or combinations thereof, having greater heat stability than a sodium-stabilized product of similar type, size, and concentration. Additional benefits include essentially no odor, contrary to ammonia stabilized slurries, low volatility, low toxicity, and a strong pH buffering capacity. The slurries may also contain other ingredients such as wetting agents, antifoam agents, biocides, polymers, and the like.

Thus, by this invention, a method of casting is disclosed in which layers of slurry (and stucco if desired) are applied to the outer surface of a pattern, in which the slurry comprises silica, stabilized with an amino alcohol, and optionally containing other ingredients such as a refractory, followed by conventional firing of the resulting shell that is formed. Drying typically takes place between the repeated applications of slurry layers.

Typically, this method may be used in conjunction with investment casting, where the pattern is made of a meltable wax or the like, which thus can be removed after the shell has been formed using the slurry of this invention and any desired layers of stucco, or other additives.

A. One such stabilized silica colloid or sol may be formed from an amino alcohol such as 2-amino-2-methyl-1-propanol (AMP) and deionized water, with the silica particles being about an average of about eleven nanometers in size, and in a concentration of about 24.7 wt. percent silica. Specifically, sodium silicate solution can be deionized by passing through a cationic exchange resin to form silicic acid solution having about 5-7 wt. percent solids and a typical pH of about 2-2.5. This solution may be fed into a reactor having the above amino alcohol present in an amount of about 0.1-1 wt. percent, based on the silica present, specifically about 0.3 percent, to grow colloid particles, for example to a size on the order of 11 nanometers. The colloid product is then concentrated by evaporation or ultrafiltration, to form a silica colloid having about 30 percent solids. The pH can be raised to about 10 with the addition of additional amino alcohol, typically about and extra 1 to 2 wt. percent of amino alcohol being needed.

B. Alternatively, a known silica colloid (Nalco 1030), stabilized with sodium, is deionized in conventional manner, and then is restabilized with about 0.1-3 wt. percent, based on the silica present, of 2-amino-2-methyl-1-propanol. The resulting material can have an average particle size of about eleven nanometers (nm), and a concentration of about 26.5 wt. percent silica.

The above disclosure and the Examples below are for illustrative purposes only, and are not intended to limit the scope of the invention, which is as defined in the claims below.

### EXAMPLE 1

Zircon (zirconium silicate) slurries were prepared, respectively including formulations of A or B above, (which contains 2-amino-2-methyl-1-propanol (called AMP)), and compared with a similar, standard, sodium-stabilized Nalco 1030 zircon slurry formulation, each without polymer enhancement. See Examples 2 and 3 for the specific, AMP-containing formulations. Physical properties were initially similar for the three slurries on storage. The pH of the conventional Nalco 1030 slurry fell farther and faster than the two slurries stabilized with AMP. The seven week stability for the two AMP-containing slurries was very good. If desired, polymer additives such as Nalco Latrix™ 6300 or 6305 may be added for improved performance in metal casting.

In firing tests, the slurries which contained AMP rather than sodium have improved high temperature strengths at temperatures at the level of 2800-3000° F., apparently because of the absence of alkali metal. At lower temperatures of about 1800° F., shells made by the above AMP-containing slurries have reduced sintering and have less strength than the sodium-containing shells, to improve removability from the casting.

Green strengths are good in the shells made with AMP rather than alkali metal, and the AMP-containing systems are very compatible with the organic polymer Latrix™ 6300, with good dispersal. Also, AMP-containing slurries can work with higher slurry solids content than the conventional alkali-metal stabilized slurries, consequently having decreased drying times, which enhances productivity.

### EXAMPLE 2

One shell for investment casting utilized a silica slurry which contained 0.3 wt. percent AMP, six slurry coats being provided to the pattern by dipping, with drying in between. After the first coat, a zircon stucco was added. After the second through the fifth coats, 14×28 C-E Minerals fused alumina was added as a stucco, followed in each case by drying, and followed with a final seal with the sixth coat of the AMP-containing slurry.

A slurry formulation was prepared having 86.8 wt. percent solids, and comprising 538 parts by weight of the silica colloid binder material of section B above; 1225 parts by weight of 200 mesh Atochem zircon; 1225 parts by weight of 325 mesh TAM zircon, 3 parts by weight of Neodol 1-5; and 2 parts by weight of Dow Corning 1430 antifoam. The number 4 Zahn viscosity of this material was 23 seconds.

The initial pH of the stabilized slurry was 10.35. The initial specific gravity of the binder was 1.1794. After two weeks the pH of the slurry remained at 10.20. After seven weeks the pH of the slurry was substantially unchanged at 10.21. The initial percent of silica in the binder material was 26.5%.

A shell that was formed had a thickness of 0.175 inch, a green modulus of rupture of 570 psi, a green fracture load of 5.67 lbs., a hot modulus of rupture of 1784 psi, a hot fracture load of 18.31 lbs. and a fired modulus of rupture of 1149 psi, and a fired fracture load of 12.15 lbs. For obtaining the hot modulus of rupture and fracture load, the shell was held for one hour at 1800° F. and then tested at the same temperature. For measuring the fired modulus of rupture and fracture load, the firing took place for 2.5 hours at 1800° F., followed by cooling and testing at room temperature.

### EXAMPLE 3

Another slurry for investment casting shells was formed from a silica sol grown with AMP stabilizer to serve as a binder, as in section A above, having a silica percentage of 24.7 wt. percent. To 532 parts by weight of this sol was added 1200 parts by weight of 200 mesh Atochem zircon; 1200 parts by weight of 325 mesh TAM zircon; three parts by weight of Neodol 1-5; and two parts by weight of Dow Corning 1430.

The number 4 Zahn viscosity was 23. The initial slurry pH was 10.35, and the initial binder specific gravity was 1.1634. After two weeks, the slurry pH was 10.12. After seven weeks, the slurry pH was 10.16. Total of slurry solids were 86.4%.

An investment casting shell was formed by the 6-coat technique described above in Example 2, to provide a shell of having a thickness of 0.173 inch. The green modulus of rupture (MOR) was 614 psi. The green fracture load was 6.19 lbs. The hot modulus of rupture was 14.97 psi. The hot fracture load was 15.24 lbs. The fired modulus of rupture was 1091 psi. The fired fracture load was 10.78 lbs. Testing conditions were similar to Example 2.

If desired, organic polymer additives such as a styrene-butadiene polymer dispersion may be added to the slurry, such as Latrix™ 6300 or 6305 of the Nalco Company, to obtain modifications of the physical properties of the resulting shells.

1. A slurry for high temperature casting which comprises: a finely divided refractory material, water, and a finely divided silica binder which is stabilized with an amino alcohol.

2. The slurry of claim 1 in which the amino alcohol has no more than 14 carbon atoms.

3. The slurry of claim 2 in which about 0.1-3 wt. percent of said amino alcohol is present, based on the weight of the silica binder.

4. The slurry of claim 2 in which the silica binder has an average particle size of essentially 11 to 20 nanometers.

5. The slurry of claim 2 in which the amino alcohol has no more than 10 carbon atoms.

6. The slurry of claim 5 in which said amino alcohol comprises 2-amino-2-methyl-1-propanol.

7. The slurry of claim 5 in which said amino alcohol comprises 2-dimethylamino-2-methyl-1-propanol.

8. The slurry of claim 2 in which said refractory material comprises zircon.

9. In a method of high temperature casting, the step which comprises: preparing a slurry of a mixture of a finely divided refractory material, water, and a finely divided silica binder which is stabilized with an amino alcohol.

10. The method of claim 8 in which an investment casting shell is prepared by repeated application of said slurry on a pattern, with drying in between the repeated applications.

11. The method of claim 8 in which layers of stucco are applied between said repeated applications.

12. The method of claim 8 in which said amino alcohol comprises 2-amino-2-methyl-1-propanol.

13. The method of claim 8 in which about 0.1-3 wt. percent of said amino alcohol is present in said slurry, based on the weight of the silica binder.

14. The method of claim 8 in which the particle size of said silica binder is essentially 11 to 20 nanometers.

15. The method of claim 8 in which said refractory material comprises zircon.

16. An aqueous silica colloid which is stabilized with an amino alcohol, the silica having an average particle size of essentially 50 to 125 nm.

17. The silica colloid of claim 15 in which about 0.1-3 wt. percent of said amino alcohol is present, based on the weight of the silica.

18. The silica colloid of claim 16 in which the amino alcohol present has no more than 14 carbon atoms per molecule.

19. The silica colloid of claim 16 in which the amino alcohol present has no more than 10 carbon atoms per molecule.

20. The silica colloid of claim 19 in which said amino alcohol comprises 2-amino-2-methyl-1-propanol.

21. The silica colloid of claim 19 in which said amino alcohol comprises 2-dimethylamino-2-methyl-1-propanol.

22. The silica colloid of claim 17 in which said average particle size is 60 to 100 nm.

23. The silica colloid of claim 17 which has a solids concentration of 15 to 50 weight percent.
